(19) United States
(12) Patent Application Publication
(10) Pub. No.: US 2015/0113263 A1
(43) Pub. Date: Apr. 23, 2015

(54) METHOD FOR UPDATING BASIC INPUT/OUTPUT SYSTEM OF SERVER

(71) Applicant: AIC INC., Taoyuan Hsien (TW)

(72) Inventors: Chih-Yung WU, Taoyuan Hsien (TW); Cheng-Yang LIN, Taoyuan Hsien (TW); Chi-Wen CHANG, Taoyuan Hsien (TW)

(73) Assignee: AIC INC., Taoyuan Hsien (TW)

(21) Appl. No.: 14/060,988

(22) Filed: Oct. 23, 2013

(51) Int. Cl. G06F 9/445

(52) U.S. Cl. CPC G06F 8/65
USPC 713/100

(57) ABSTRACT

A method for updating a basic input/output system of a server is disclosed. The method can be done by that of activating a customer end server; a BIOS initializing a network interface card; the customer end server linking a management end server; transmitting a product serial number of the customer end server and a version of the BIOS to the management end server for determination; if the management end server determines that the BIOS does need to be updated, the customer end server downloading the latest BIOS; the customer end server directly accessing a flash memory in the customer end server via an access program code in the BIOS, so as to burn the latest BIOS into the flash memory. Hence the customer end server automatically updates the BIOS therein while in a POST (power-on self-test) without entering into an operating system.

### BACKGROUND OF THE INVENTION

1. Field of the Invention

The present invention generally relates to a method for updating a server, more particularly to a method for a server automatically updating a BIOS therein.

2. Description of the Related Art

Each of computer devices has a BIOS (basic input/output system). BIOS is a firmware that is firstly executed by a computer device being turned on; besides, BIOS is to check each part of hardware of the computer device and initialize each part as well.

For a general computer device, BIOS is a very important firmware. Especially, a good BIOS not only accelerates the speed of a computer, but also increases the stability of the computer. Hence, computer producers always put more attentions for the update and maintenance of BIOS, and duly provide new versions of BIOS.

While preparing to update BIOS, a computer device is activated first and enters into an operating system as Linux, Windows, etc., then updating software in the operating system is going to update BIOS. However, above procedures are to completely execute the operating system firstly, and the operating system shall be installed proper software. Accordingly, to update BIOS will spend a large amount of time, and it makes a high cost.

Besides, some other motherboard producers provide another updating way. That is, an additional updating module is installed on a motherboard, and the updating module determines whether there is a latest BIOS via a network while in boot process. If there is a latest BIOS, the latest BIOS is thus downloaded to replace the older BIOS. However, such a way shall install the updating module on the motherboard so as to cause the additional cost of hardware, and therefore definitely the cost of a computer device is increased.

### SUMMARY OF THE INVENTION

The main objective of the present invention is to provide a method for updating a basic input/output system of a server, wherein the BIOS (basic input/output system) can automatically update by itself when the server is in a POST (power-on self-test) process without entering into an operating system for updating.

The second objective of the present invention is to provide a method for updating a basic input/output system of a server, wherein an access program code, directly accessing the flash memory of a customer end server, is written into the BIOS, so that the customer end server may not be equipped with an additional updating module, and the BIOS itself can engage in a burning process for recording.

To reach above objectives, the present invention can be done by that of activating a customer end server; a BIOS initializing a network interface card; the customer end server linking a management end server; transmitting a product serial number of the customer end server and a version of the BIOS to the management end server for determination; if the management end server determines that the BIOS does need to be updated, the customer end server downloading the latest BIOS; and the customer end server directly accessing a flash memory in the customer end server via an access program code in the BIOS, so as to burn the latest BIOS into the flash memory.

Compared to related arts, the present invention has the advantages listed below:

(1) The BIOS itself initializes the network interface card, links the management end server, and downloads the latest BIOS after activating the customer end server.

(2) The access program code, directly accessing the flash memory in the customer end server, is written into the BIOS, so that the BIOS itself is able to directly burn the latest BIOS to the flash memory.

As it can be seen, the customer end server may not be equipped with an additional updating module, therefore the hardware cost of the customer end server is saved. Besides, the customer end server updates software therein without entering an operating system, therefore the updating time of the BIOS is effectively shortened as well.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic system structure of a first embodiment of the present invention;

FIG. 2 illustrates a block diagram of the first embodiment of the present invention;

FIG. 3 illustrates a schematic view of an updating file of the first embodiment of the present invention;

FIG. 4 illustrates a check flow chart of the first embodiment of the present invention;

FIG. 5 illustrates an updating flow chart of the first embodiment of the present invention; and

FIG. 6 illustrates an updating timing diagram of the first embodiment of the present invention.

### DETAILED DESCRIPTION OF THE INVENTION

Following preferred embodiments and figures will be described in detail so as to achieve aforesaid objects.

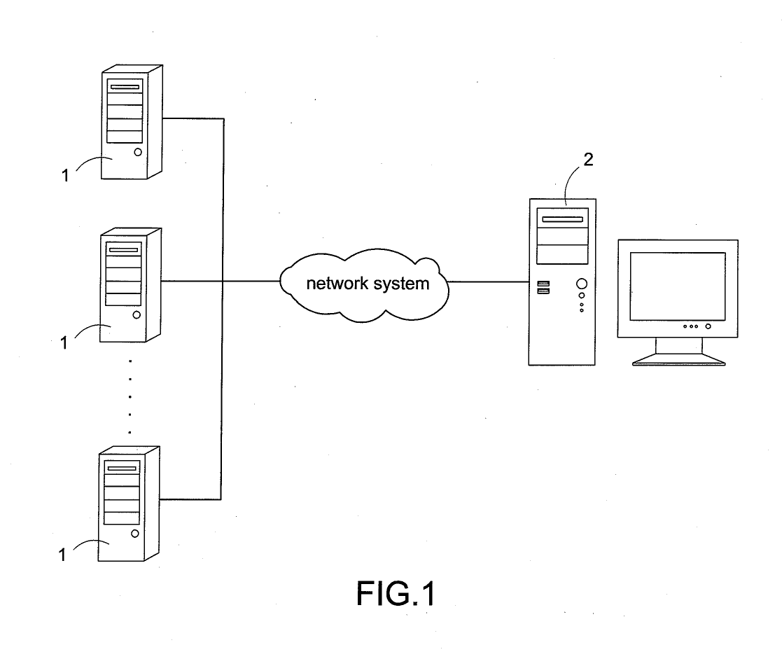

Please refer to FIG. 1, which illustrates a schematic system structure of a first embodiment of the present invention. The present invention provides a method for updating a basic input/output system for a server. The method lets one or plural customer end servers 1 link at least one management end server 2 via a network, and the management end server 2 updates a BIOS (basic input/output system) therein based on the result of the management end server 2 comparing the versions of the BIOS.

Practically, for the embodiment, the method is applicable to an LAN (local area network). The plural customer end servers 1 and the management end server 2 are servers under the same enterprise, company or circumstance and connecting with the same LAN. However, for other embodiments, the servers 1 and 2 are able to connect with each other via a WAN (wide area network), but not limited thereto.

For the present invention, the management end server 2 is able to update the plural customer end servers 1, and only one customer end server 1 is also able to ask a request of updating to one or more management end servers 2. It will be described in the following descriptions for one customer end server 1 linking one management end server 2.

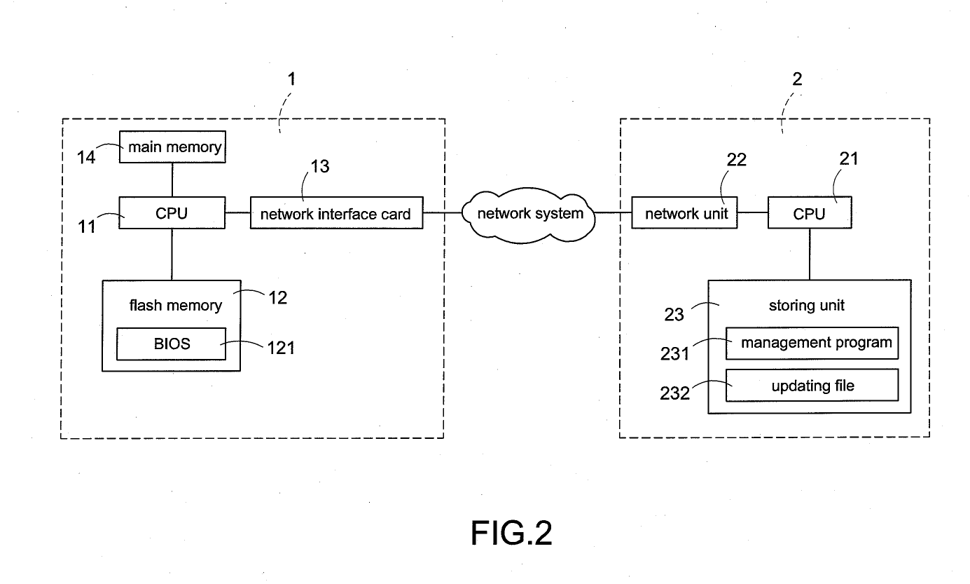

Please refer to FIG. 2, which illustrates a block diagram of the first embodiment of the present invention. As shown in figure, the customer end server 1 has a motherboard (not shown in figure), the motherboard mainly has a CPU 11, a flash memory 12, a network interface card 13, and a main memory 14, wherein the CPU 11 electrically connects with the flash memory 12, the network interface card 13, and the main memory 14 via the motherboard in order to cooperatively process data transmissions among the flash memory 12, the network interface card 13, and the main memory 14. The customer end server 1 connects with a network system via the network interface card 13 in order to link the management end server 2 and download files for updating.

For the embodiment, the flash memory 12 is an SPI flash (serial peripheral interface flash) on the motherboard, and a BIOS 121 for the customer end server 1 is burned into the flash memory 12. The characteristics of the present invention are to use the BIOS 121 to determine whether the BIOS 121 is updated, and download an updating file from the management end server 2 while updating is a must, and the BIOS 121 itself is able to burn the updating file into the flash memory 12. In other words, through the present invention, the customer end server 1 may not be equipped with an additional updating module, so as to lower down the hardware cost of the customer end server 1. Further, the customer end server 1 can update the BIOS 121 in time while in a POST (power-on self-test) process without entering into an operating system, hence the updating time is shortened.

The management end server 2 has a motherboard (not shown in figure) as well, and the motherboard has a CPU 21, a network unit 22, and a storing unit 23. The CPU 21 electrically connects with the network unit 22 and the storing unit 23 in order to cooperatively process data transmissions between the network unit 22 and the storing unit 23. The management end server 2 connects with the network system through the network unit 22 in order to link the customer end server 1, and therefore the management end server 2 receives an updating request from the customer end server 1 and provides an updating file. The storing unit 23 can be a memory or a hard disc. The management end server 2 stores a management program 231 and at least one updating file 232 via the storing unit 23.

For the present invention, the management end server 2 mainly supports an iSCSI (internet small computer system interface). Hence, via the iSCSI, a TCP/IP (transmission control protocol/Internet protocol) is being used to connect the management end server 2 with the one or more customer end servers 1. Simultaneously, the management end server 2 provides a DHCP (dynamic host configuration protocol) service and an FTP (file transfer protocol) service for offering a useable IP (Internet protocol) address to the one or more customer end servers 1, and transmits data and files to the one or customer end servers 1 with each other.

The management program 231 is a program that is developed by an enterprise, using the two servers 1 and 2, or a factory, manufacturing the two servers 1 and 2. The management end server 2 is executed by the management program 231, and therefore communications to the customer end server 1 is controlled by the management program 231 as well. It is obvious that messages and files are transmitted from the management end server 2 to the customer end server 1 or vice versa. Besides, when the customer end server 1 needs to be updated for the BIOS 121, the management program 231 further provides a download procedure of the updating file 232 while the customer end server 1 needs to update the updating file 232.

For the embodiment, the updating file 232 is an image file which extension is “bin”. When the customer end server 1 updates the BIOS 121, the updating file 232 in the management end server 2 is thus downloaded for updating.

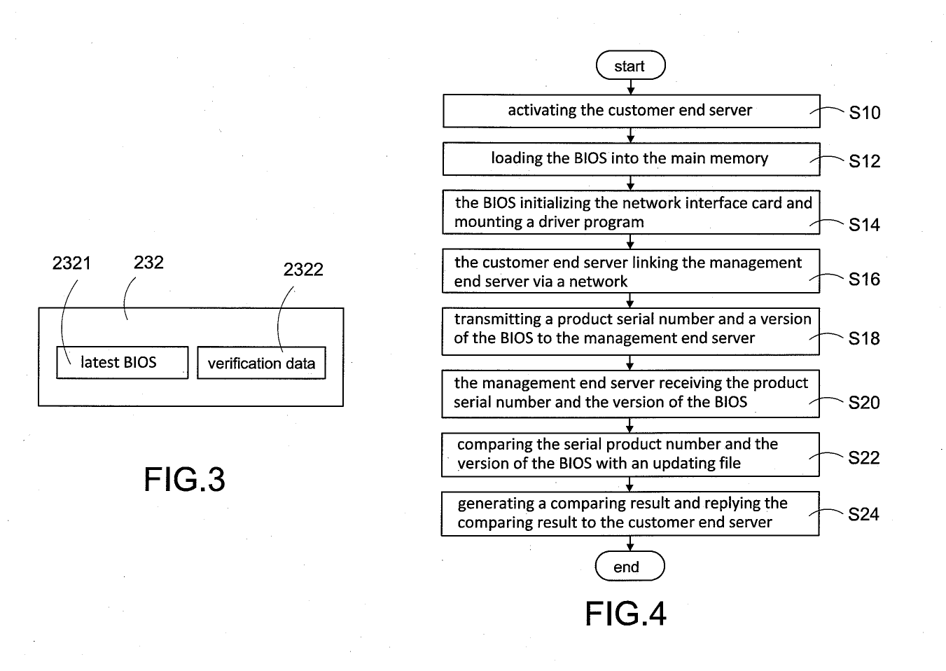

Please refer to FIG. 3, which illustrates a schematic view of the updating file of the first embodiment of the present invention. As shown in figure, the updating file 232 mainly has a latest BIOS 2321 and verification data 2322. When the customer end server 1 proceeds updating, the latest BIOS 2321 is burned to the flash memory 12 to replace the BIOS 121.

For the embodiment, the verification data 2322 is mainly a hash function value of the latest BIOS 2321. In practice, the latest BIOS 2321 will engage in the hash function when an engineer manufactures the latest BIOS 2321. When a hash parameter value is obtained, the value can be the verification data 2322. The latest BIOS 2321 and the verification data 2322 may be put together to become the updating file 232. After the customer end server 1 downloads the updating file 232, the downloaded latest BIOS 2321 is determined for complete or incomplete according to the verification data 2322. The update may not be proceeded until the downloaded latest BIOS 2321 is complete. Accordingly, the BIOS not executing regularly to cause problems can be avoided if the BIOS updated by the customer end server 1 is incomplete.

Please refer to FIG. 4, which illustrates a check flow chart of the first embodiment of the present invention. The method comprises the steps of:

(S10) activating the customer end server 1;

(S12) the customer end server 1 accessing the BIOS 121 of the flash memory 12, and loading the BIOS 121 into the main memory 14 for execution;

(S14) the customer end server 1 executing a POST (power-on self-test) process through the BIOS 121 of the main memory 14, the BIOS 121 initializing the network interface card 13 and mounting a driver program of the network interface card 13 while in the POST process, so as to let the customer end server 1 connect with the network;

There is one thing to be noted. The BIOS 121 is mainly a UEFI (unified extensible firmware interface), and the driver program mounted by the BIOS 121 is a LAN (local area network) driver program of a UEFI, but not limited thereto. Through the BIOS and the driver program of the UEFI, the customer end server 1 may not enter into the operating system and directly activate the network interface card 13 via the BIOS 121, and the customer end server 1 connects with the management end server 2 through the network.

(S16) after mounting the driver program, the customer end server 1 linking the network via the network interface card 13 in order to connect with the management end server 2;

(S18) the customer end server 1 transmitting a product serial number of the customer end server 1 and a version of the BIOS 121 to the management end server 2;

(S20) the management end server 2 mainly executing the management program 231 in order to receive the product serial number and the version of the BIOS 121 transmitted by the customer end server 1;

(S22) the management end server 2 comparing the serial product number and the version of the BIOS 121 with the updating file 23;

(S24) generating a comparing result, and replying the comparing result to the customer end server 1;

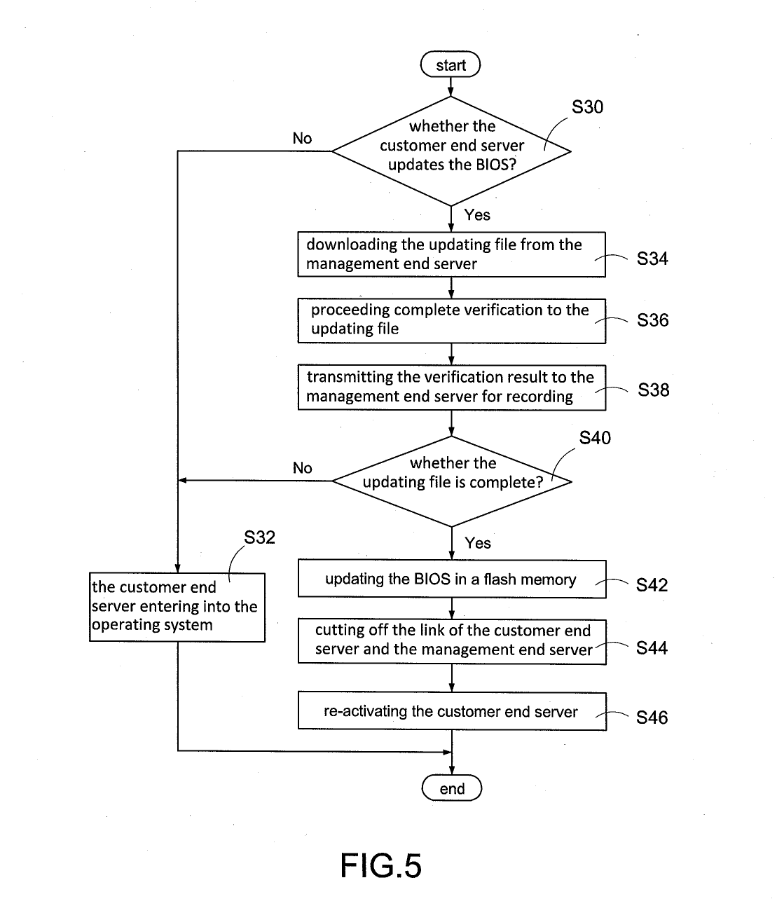

hence, the customer end server 1 and the management end server 2 determine whether the present BIOS 121 executed by the customer end server 1 is updated, that is, the latest BIOS 2321 of the updating file 232 is later than the BIOS 121 or not. Please refer to FIG. 5, which illustrates an updating flow chart of the first embodiment of the present invention. (S30) the management end server 2 being able to determine whether the customer end server 1 updates the BIOS 121 based on aforesaid comparing result, simultaneously, the BIOS 121 of the customer end server 1 determining whether the updating file 232 is downloaded from the customer end server 2 based on the comparing result;

(S32) if the determination in (S30) is that to update the BIOS 121 is not a must, the customer end server 1 directly entering into the operating system, in practice, the customer end server 1 entering into the operating system for a boot process shall be after the POST process;

(S34) if the determination in (S30) is that to update the BIOS 121 is a must, the customer end server 1 downloading the updating file 232 from the management end server 2 via the BIOS 121. Thus, the BIOS 121 uses the downloaded updating file 232 to update;

(S36) if the downloaded updating file 232 is incomplete, the customer end server 1 being possibly out of order after updating, hence, the customer end server 1 selectively proceeding complete verification to the updating file 232 before updating;

(S38) the customer end server 1 selectively generating a verification result and transmitting the verification result to the management end server 2 for recording after completing the verification;

(S40) the BIOS 121 determining whether the updating file 232 is complete, if the determination is that the updating file 232 is incomplete, the customer end server 1 not executing the updating, going to the step (S32), if the determination is that the updating file 232 is complete, going to (S42);

(S42) the BIOS 121 executing the updating according to the updating file 232;

For the embodiment, the BIOS 121 first decodes the downloaded updating file 232, which has the latest BIOS 2321 and the verification data 2322. Continuously, the BIOS 121 further executes the hash functions to the latest BIOS 2321 so as to obtain a hash function value. If the latest BIOS 2321 is complete, and the verification data 2322 are complete as well, therefore the hash function value from the BIOS 121 should be the same as the verification data 2322. Therefore, the BIOS 121 determines whether the hash function value is equal to the verification data 2322, if yes, the updating file 232 is completely downloaded, if no, the updating file 232 is not completely downloaded. To avoid that the updated customer end server 1 may not work properly, the BIOS 121 will not use an incompletely downloaded updating file for updating.

There is one thing to be noted. The management end server 1 receives the product serial number and the version of the BIOS 121 uploaded by the customer end server 1, replies the comparing result to the customer end server 1, transmits the updating file 232 to the customer end server 1, receives the verification result of the updating file 232 to the customer end server 1, etc. However, aforementioned are the preferred embodiments of the present invention, but not limited thereto.

For the step (S42), the customer end server 1 executes the updating via the BIOS 121. More practically, the BIOS 121 is written into a special access program code. The access program code has an access protocol that is able to access the SPI flash. Hence, for the step (S42), the BIOS 121 executes the access program code therein to access the flash memory 12 of the customer end server 1, and directly burns the latest BIOS 2321 to the flash memory 12 for completing updating. The present invention is able to use the access program code of the BIOS 121 to directly access the flash memory 12 so as to burn the latest BIOS 2321. As it can be seen, the customer end server 1 may not be equipped with an additional hardware to burn the BIOS that needs to be updated.

After the step (S42), the customer end server 1 finishes the updating.

(S44) selectively cutting off the link of the customer end server 1 and the management end server 2, wherein the request of cutting off is issued by the customer end server 1 or the management end server 2, but not limited thereto; and

(S46) re-activating the customer end server 1.

After the customer end server 1 is activated, the BIOS 121 in the main memory 14 are deleted, and the BIOS in the flash memory 12 is updated to the latest BIOS 2321. So, the customer end server 1 loads the latest BIOS 2321 in the flash memory 12 into the main memory 14 for execution.

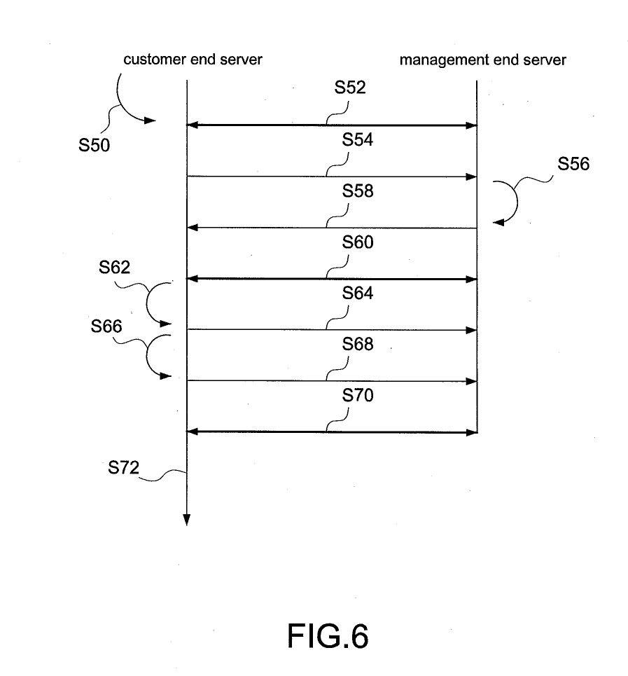

Please refer to FIG. 6, which illustrates an updating timing diagram of the first embodiment of the present invention. In view of timing, the method of the present invention comprises the steps of:

(S50) activating the customer end server 1;

(S52) building up a network linking the customer end server 1 and the management end server 2;

(S54) uploading the product serial number and the version of the BIOS 121 to the management end server 2;

(S56) the management end server 2 comparing the versions;

(S58) replying the comparing result to the customer end server 1;

(S60) if the comparing result is that updating is a must, the customer end server 1 downloading the updating file 232 from the management end server 2;

(S62) verifying whether the updating file 232 is complete;

(S64) transmitting the verification result to the management end server 2 for recording;

(S66) the customer end server 1 updating the BIOS 121 based on the updating file 232;

(S68) transmitting the updating result to the management end server 2 for recording;

(S70) cutting off the link of the customer end server 1 and the management end server 2; and

(S72) re-activating the customer end server 1 for running the updated BIOS.

Since the BIOS 121 and the latest BIOS 2321 of the present invention both have special program codes, such as aforesaid program code able to access the SPI flash, thus the latest BIOS 2321 can be burned to the flash memory 12 via the BIOS 121. As it can be seen, the customer end server 1 may not be equipped with an additional hardware and may not enter into the operating system for using the updated software in the operating system, continuously the BIOS can be updated directly through the BIOS 121. So, the hardware cost of the customer end server 1 is lowered down and the updating time is shortened effectively as well.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for updating a basic input/output system (BIOS) of a server, applying to a customer end server (1) and a management end server (2), the customer end server (1) having a BIOS (121), the method comprising the steps of:
(a) activating the customer end server (1);
(b) the BIOS (121) initializing a network interface card (13) of the customer end server (1), and mounting a driver program of the network interface card (13);
(c) the customer end server (1) linking the management end server (2) via a network, and transmitting a product serial number of the customer end server 1 and a version of the BIOS (121) to the management end server (2);
(d) the management end server (2) comparing the product serial number and the version of the BIOS (121) with an updating file (232) in order to determine whether the BIOS (121) needs to be updated;
(e) following the step (d), if the BIOS (121) does not need to be updated, the customer end server (1) entering into an operating system;
(f) following the step (d), if the BIOS (121) does need to be updated, the customer end server (1) downloading the updating file (232) from the management end server (2);
(g) following the step (f), the BIOS (121) executing an access program code therein in order to access a flash memory (12) in the customer end server (1), and recording a latest BIOS (2321) of the updating file (232) into the flash memory (12); and
(h) following the step (g), re-activating the customer end server (1).

2. The method for updating a basic input/output system of a server according to claim 1, wherein the flash memory (12) is an SPI flash (serial peripheral interface flash), and is disposed on a motherboard in the customer end server (1), the driver program being for an LAN (local area network) of a UEFI (unified extensible firmware interface).

3. The method for updating a basic input/output system of a server according to claim 2 further comprising a step (i) of: following the step (d), the management end server (2) replying a comparing result to the customer end server (1), in the step (f), the BIOS (121) determining whether the updating file (232) is downloaded based on the comparing result.

4. The method for updating a basic input/output system of a server according to claim 2 further comprising a step (h01), before the step (h), of: cutting off the link of the customer end server (1) and the management end server (2).

5. The method for updating a basic input/output system of a server according to claim 2, wherein the BIOS (121) is recorded into the flash memory (12) and further comprises steps, after the step (a), of:
(a1) the customer end server (1) accessing the BIOS (121) in the flash memory (12) and loading into a main memory (14) of the motherboard; and
(a2) executing the BIOS (121) of the main memory (14).

6. The method for updating a basic input/output system of a server according to claim 2, wherein the updating file (232) is an image file, and the extension of the image file is bin, the updating file (232) having the latest BIOS (2321) and verification data (2322).

7. The method for updating a basic input/output system of a server according to claim 6 further comprising steps, after the step (f), of:
(f1) the BIOS (121) completely verifying the updating files (232);
(f2) transmitting a verification result to the management end server (2) for recording;
(f3) following the step (f1), if the updating file (232) is not complete, the customer end server (1) directly entering into the operating system; and
(f4) following the step (f1), if the updating file (232) is complete, executing the step (g).

8. The method for updating a basic input/output system of a server according to claim 7, wherein the verification data (2322) is a hash parameter value of the latest BIOS (2321) and the step (f1) further comprises steps of:
(f11) the BIOS (121) decoding the updating file (232) and obtaining the verification data (2322) and the latest BIOS (2321);
(f12) executing hash functions to the latest BIOS (2321) in order to obtain a hash function value; and
(f13) comparing the hash function (f13) to determine whether the hash function value is equal to the verification data (2322).

9. The method for updating a basic input/output system of a server according to claim 7, wherein the management end server (2) has a management program (231), the management end server (2) receiving the product serial number of the customer end server (1) and the version of the BIOS (121), replying the comparing result to the customer end server (1), transmitting the updating file (232) to the customer end server (1), and receiving the verification result of the updating file (232) from the customer end server (1) via the management program (231).

10. A method for updating a basic input/output system (BIOS) of a server, applying to a customer end server (1) and a management end server (2), the customer end server (1) having a motherboard, the motherboard having an SPI flash (serial peripheral interface flash) (12), a main memory (14), and a network interface card (13), a BIOS (121) being recorded in the SPI flash (12), the method comprising the steps of:
(a) activating the customer end server (1);
(b) accessing the BIOS (121) of the SPI flash (12), and loading into the main memory (14);
(c) executing the BIOS (121) of the main memory (14);
(d) the BIOS (121) initializing the network interface card (13), and mounting a local network driver program of a UEFI (unified extensible firmware interface);
(e) following the step (d), the customer end server (1) linking the management end server (2) via a network, and transmitting a product serial number of the customer end server (1) and a version of the BIOS (121) to the management end server (2);
(f) the management end server (2) comparing the product serial number and the version of the BIOS (121) with an updating file (232);
(g) following the step (f), the management end server (2) replying a comparing result to the customer end server (1);
(h) following the step (g), the BIOS (121) determining whether the updating file (232) is downloaded based on the comparing result;
(i) following the step (h), if no, the customer end server (1) entering into an operating system;
(j) following the step (h), if yes, the customer end server (1) downloading the updating file (232) from the management end server (2), wherein the updating file (232) has the latest BIOS (2321) and verification data (2322), the verification data (2322) being a hash parameter value of the latest BIOS (2321);
(k) following the step (j), the BIOS (121) executing hash functions to the latest BIOS (2321) in order to obtain a hash function value;
(l) comparing the hash function value with the verification data (2322) to determine whether the downloaded updating file (232) is complete;
(m) following the step (1), if no, the customer end server (1) directly entering into the operating system;
(n) following the step (1), if yes, the BIOS (121) executing an access program code therein to access the SPI flash (12), and burning the latest BIOS (2321) into the SPI flash (12); and
(o) following the step (n), re-activating the customer end server (1).
